(19) United States
(12) Patent Application Publication
(10) Pub. No.: US 2022/0090375 A1
(43) Pub. Date: Mar. 24, 2022

(54) THREE-DIMENSIONAL HEAT-SAVING CONSTRUCTION PANEL, DEVICE AND METHOD FOR PREPARING SAME

(71) Applicant: uulu Usenkul CHOLPONALY, Bishkek (KG)

(72) Inventor: uulu Usenkul CHOLPONALY, Bishkek (KG)

(21) Appl. No.: 17/426,307

(22) PCT Filed: Dec. 5, 2019
(86) PCT No.: PCT/KG2019/000001

§ 371 Date: Jul. 28, 2021

(30) Foreign Application Priority Data
Feb. 6, 2019 (KG) 20190007.1

(51) Int. Cl. E04B 1/80

(52) U.S. Cl. CPC E04B 1/803

(57) ABSTRACT

The invention relates to the field of construction, namely to building structures, methods and arrangements for their production and can be used as heat-saving three-dimensional panels for the rapid construction of load-bearing walls of buildings of various purposes and floors in them, external walls, partitions, roofs, meeting the requirements of the increased thermal resistance of building envelopes in the construction industry.

The objective of the invention is creation of a wall heat-saving three-dimensional panels (options) of the increased thermal resistance that meet the requirements of the parameters of the “passive house”, development of a method for its manufacture, which reduces the material consumption, energy consumption and laboriousness, and development of the design of the block-form (options) for its manufacture.

The problem is solved in such a way that a construction heat-insulating three-dimensional panel designed for load-bearing walls, is made in the form of a thermostructural structure of a heat-insulating core, reinforcing support elements in the form of trellised trusses with a cavity under the seismic belt, and a wire mesh, at forming of which recesses are made evenly and in mutual parallel on the front and rear surfaces, and protrusions are made on the upper and lower surfaces between the protruding surfaces of the support elements.

The problem is solved in such a way that in a construction heat-insulating three-dimensional panel designed for floor slabs made in the form of a thermostructural structure of a heat-insulating core, reinforcing support elements made in the form of lattice trusses, and a wire mesh, at forming of which the front and rear surfaces are made smooth with protruding surfaces of the reinforcing supporting elements, and on the upper and lower surfaces protrusions are made located between the protruding surfaces of the supporting elements.

The problem is also solved with a method of manufacturing of construction insulating three-dimensional panel comprising filling the form cavity with the pre-foamed polystyrene granules, forming the blocks, cooling, stabilizing, removing the finished blocks from the block-form. Filling the block-form into the guide grooves is performed after installation of the reinforcing support grooves in the guide grooves elements.

The problem is also solved by the development of a closed-type block-form for the manufacture of panels for load-bearing walls, made in the form of a vertically oriented housing mounted on a support and equipped with nozzles for connecting to coolant supply systems, evacuation and condensate removal, a pre-foamed filler granules loading unit, consisting of movable front wall, rear wall, side walls, upper and lower walls. The longitudinal clamping grooves are made on the front wall, the longitudinal thrust grooves are made on the rear wall, between which the forming protrusions are made evenly and in mutual parallel, and transverse guide grooves are made on the upper and lower wall, between which the forming grooves are made.

The problem is also solved by the development of a closed-type block-form for the manufacture of panels used as floor slabs, made in the form of a vertically oriented housing mounted on a support and equipped with nozzles for connection with coolant supply, evacuation and condensate removal systems, loading unit for the pre-foamed filler granules, consisting of a movable front wall, rear wall, side walls, upper and lower walls, and longitudinal clamping grooves. The longitudinal persistent grooves are made on the rear wall, the transverse guide grooves are made on the upper and lower wall, between which the forming grooves are made.

The invention relates to the field of construction, namely to building structures, methods and arrangements for their production and can be used as heat-saving three-dimensional panels for the rapid construction of load-bearing walls of buildings of various purposes and floors in them, external walls, partitions, roofs, meeting the requirements of the increased thermal resistance of building envelopes in the construction industry.

More than 70% of heat loss in homes occurs through walls, windows and ceilings, and as a result, energy resources are used excessively to achieve a comfortable temperature (and, consequently, the cost of paying for them increases). Therefore, the development of the advanced energy-saving technologies and materials that maximally satisfy the technical, construction, hygiene and operational requirements is a particularly urgent task.

Construction products from foaming materials, such as expanded polystyrene, are almost weightless, convenient for transportation and installation, durable, reliable, and therefore are widely used in construction, for example, as construction panels made in the form of plates having the required dimensions and shape, equipped with reinforcing elements in the form metal rods, profiles, grids, etc.

A prefabricated panel with reinforcing filler (U.S. Pat. No. 4,226,067, class E04C 2/26, 7 Oct. 1980) is known. It contains the foamed filler in the form of bars placed between two side-frames in the form of zigzag trusses on the right and left, forming an assembly element, then several of such elements are assembled together, joined tightly together in the transverse direction, forming a panel of the required size, then, by the upper and lower end parts of the zigzag, trusses are welded on both sides by spot welding to wire mesh, fixing first longitudinal and then transverse rods.

A structural panel (patent UA No. 46938, U, class E04C class 2/02, 2/10, 11 Jan. 2010) is known. It contains a core in the form of a filler layer, on both sides of which are wire mesh and a series of parallel flat zigzag wire supporting elements that pass through the core and are connected by ridges to wire mesh, while the ridges have longitudinal shelves. The core thickness can be from 100 to 250 mm, the mesh cells are made in size of 25×25 mm.

An armored reinforced panel of class EVG 3D under the brand name ARBON LLC “Factory of Alternative Technologies” (Alfateh) (http://www.arbon.com.ua/material-2) is known. It is a spatial truss structure consisting of reinforcing meshes of high-strength wire with a diameter of 3 mm and a mesh size of 50×50 mm and galvanized or stainless rods welded at an angle to the nets, piercing the core of expanded polystyrene foam with a thickness of 120 mm for external walls and 50 mm for internal ones.

The known panels have advantages in terms of energy consumption, thermal protection, thermal insulation, comfort, simplicity, speed and cost of construction, strength and durability, in addition, there is no need for lifting equipment—panels can be installed manually. However, they are used only as enclosing construction elements that perform the functions of insulation, sound insulation. It should be noted that the known constructions do not provide the required adhesion to the plaster.

Also, the disadvantages of the known solutions are the limitation in the parameter of the maximum thickness—250 mm of expanded polystyrene in the panel, which does not meet the requirements of thermal resistance index of the external walls for the “passive house”, and the inability to install a seismic belt on such panels without forming a cold bridge. Currently, the concept of the “passive house” in Europe corresponds to thermal resistance of external walls and is equal to R≥6.7 (m2° C.)/W (https://www.smartcalc.ru/thermocalc?&gp=229&rt=0&ct=0&os=0&ti=20&to=-10&hi=55&ho=85).

Finished boards made of a foaming material, for example expanded polystyrene for the above-mentioned known structures, are made by dividing into parts of a predetermined thickness of a semi-finished product (“block”), which has a substantially parallelepiped shape.

Such a block is manufactured on discrete-type forming machines (“block-forming plants”) in which block-forms having a profile corresponding to the profile of the formable block are used.

For the prototype, a vertical block-form of cyclic action and closed type (company NUOVA IDROPRESS SpA, Italy, http://www.nuova-idropress.com/Sezione.jsp?titolo=blocchiere&idSezione=7) is chosen. It is made in the form of a vertically oriented body, equipped with nozzles for connecting, respectively, with coolant supply, vacuum and condensate removal systems, a pre-foamed filler granules loading unit, consisting of a movable front wall, rear wall, side walls, upper and lower walls, mounted on a support. The block-form is equipped with a processor and a touch screen, which allows to automate the opening and closing of the form, the supply of material, vaporization, temperature maintenance, vacuum cooling, form release and block pushing out.

In the known device, in each forming cycle, a metered amount of pre-foamed granules from a foaming material, for example expanded polystyrene, is loaded into a block-form and they are baked under the influence of heat and pressure to form in the result a block of the desired size and shape. Upon completion of forming and the subsequent stabilization, the block-form is opened and the block obtained by the described method is removed from it and subsequently cut into plates (sheets) having a desired thickness. The block-form after removing the block is ready to receive new granules and to the beginning of a new manufacturing cycle.

The finished product comes in the form of a block with smooth side and end surfaces that do not provide the required adhesion to the plaster. In addition, the known method and block-form are not intended for manufacture of products with internal reinforcing elements, such as metal reinforcement.

A structural panel is known, which was taken as a prototype (patent RU No. 2059774, C1, class E04C 2/22, 10 May 1996), containing a solid heat-insulating core in the form of a filler layer, on both sides of which in parallel to its surfaces and with a gap, are wire mesh with longitudinal wires that are connected to the ridges of flat zigzag wire support elements passing through the heat-insulating core. The method of its manufacture includes the formation of a regular trapezoidal slots and inverted trapezoidal slots in a continuous heat-insulating core with a predetermined interval, and introduction of corresponding support wire elements into them. Slots are made in the finished heat-insulating core using a punch in the form of a blade of regular triangular shape or an inverted triangular shape.

The heat-insulating core can be made by the known technology of forming of pre-foamed polystyrene granules in a standard widely used automatic block-form with a smooth even surface of all faces and then cutting the block on a panel of the required thickness, or by forming in a specially manufactured collapsible forming metal frame, on the inner surface of one side of the forming frame along its entire length and width is installed at predetermined intervals trapezoidal metal plates of regular shape, and on the inner surface of the opposite side of the forming frame along its entire length at specified intervals, a number of fixed inverted inverted trapezoidal metal plates are installed, while the plates are located among a number of trapezoidal metal plates of regular shape in such a way that they alternate if seen from the side.

The manufacture of a known panel requires careful observance of the correspondence between the step of arrangement of the zigzag wire support elements and the size of the mesh cells or the selection of the sizes of the ridges of zigzag wire support elements to ensure the contact of the ridges of zigzag wire support elements with mesh elements during operation of connecting one element to another (for example spot welding), which reduces the manufacturability and productivity of production and puts forward the increased requirements for qualification of personnel, requires a significant investment of time and money.

The disadvantages of the known solutions also include the complexity of technical implementation of the method due to the fact that the additional equipment with a guiding device with a punch is necessary, with dimensions corresponding to the dimensions of the manufactured support zigzag elements, the need to maintain the size of the gap being made, while these slots should be as narrow as possible for the subsequent introduction of support elements, while the punch is additionally used with heating. This is necessary in order to prevent the support elements from falling out of the core, displacement of the core between the upper and the lower wire mesh during transportation or when spraying the cement mixture.

The known panel does not meet the requirements of thermal resistance index of the external walls for a “passive house”; it is impossible to install a seismic belt on such panels without forming a cold bridge. In addition, the smooth outer surfaces of the expanded polystyrene in the known panel have low adhesive indicators for adhesion to the solution imposed by spraying a fluid mixture, for example cement mortar, since there will be a slip of the applied mixture on the smooth surface of a heat-insulating core.

The forming process can be performed by the sequence of actions contained in the known method of manufacture of large-sized blocks from polystyrene foam (patent SU No. 1790516, A3, class. B29C 67/20, B 29 [symbol] 105: 04, 23 Jan. 1993), taken as a prototype, including filling of forms, forming surfaces of which are coated with non-stick grease with pre-foamed polystyrene granules, form closure and forming of blocks by feeding the steam into the form using a “heat stroke” method, stopping of steam supply, holding for 6-8 minutes, cooling, performed cyclically, by the method of “cold stroke” for 6-9 minutes, then cooling the form under natural conditions at 40-45° C., opening the form and removing the finished block.

The known method does not allow to produce blocks with reinforcing supporting structures located inside for the manufacture of three-dimensional panels.

The objective of the invention is creation of a wall heat-saving three-dimensional panel (options) of the increased thermal resistance that meets the requirements of the parameters of the “passive house”, the development of a method for its manufacture, which reduces the material consumption, energy consumption and laboriousness, and the development of the design of the block-form (options) for its manufacture.

The problem is solved in such a way that the construction heat-insulating three-dimensional panel designed for load-bearing walls, made in the form of a thermostructural structure of a heat-insulating core, reinforcing support elements in the form of trellised trusses with a cavity under the seismic belt and a wire mesh, during the formation of which between the protruding surfaces of the support elements on front and rear surfaces even and mutually parallel recesses are made, and on the upper and lower surfaces protrusions are made.

The problem is solved in such a way that in a construction heat-insulating three-dimensional panel designed for floor slabs made in the form of a thermostructural structure of a heat-insulating core, reinforcing support elements in the form of lattice trusses, and a wire mesh, when forming the front and back surfaces are made smooth with protruding surfaces of reinforcing support elements, and on the upper and lower surfaces protrusions are made located in a mutual parallel and evenly between the protruding surfaces of the supporting elements.

The problem is also solved in a method for manufacturing a construction heat-insulating three-dimensional panel, including filling the form cavity with pre-foamed polystyrene granules, forming of blocks, cooling, stabilizing, removing of the finished blocks from the block-form, while filling the block-form is performed after installation of reinforcing support elements into the guide grooves.

The problem is also solved by the development of a closed-type block-form for the manufacture of panels for load-bearing walls, made in the form of a vertically oriented housing, mounted on a support and equipped with nozzles for connecting to coolant supply, evacuation and condensate removal systems, a pre-foamed filler granules loading unit, consisting of a movable front wall, rear wall, side walls, upper and lower walls. Longitudinal clamping grooves are made on the front wall, longitudinal thrust grooves are made on the rear wall, between which the forming projections are uniformly and mutually parallel, and transverse guide grooves are made on the upper and lower wall, between which the forming grooves are made.

The problem is also solved by developing a closed-type block-form for the manufacture of panels for use as floor slabs, made in the form of a vertically oriented housing, mounted on a support and equipped with nozzles for connection with coolant supply, evacuation and condensate removal systems, and a pre-foamed filler granules loading unit consisting of a movable front wall, rear wall, side walls, upper and lower walls. Longitudinal clamping grooves are made on the front wall, longitudinal stop grooves are made on the rear wall, transverse guide grooves are made on the upper and lower wall, between which the forming grooves are made.

The drawing on

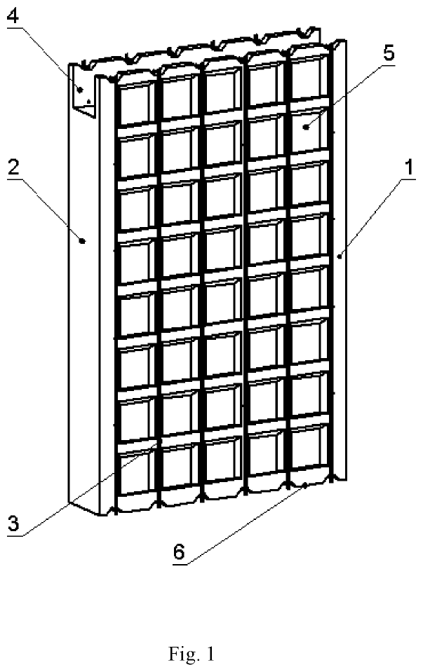

FIG. 1—general view of a panel for load-bearing walls with cuts;

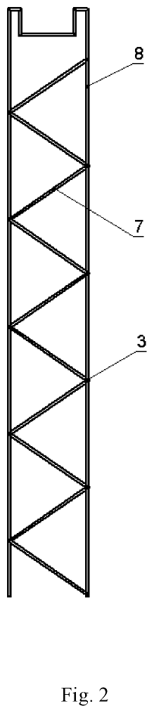

FIG. 2—perspective view of a reinforcing supporting element of a panel for load-bearing walls;

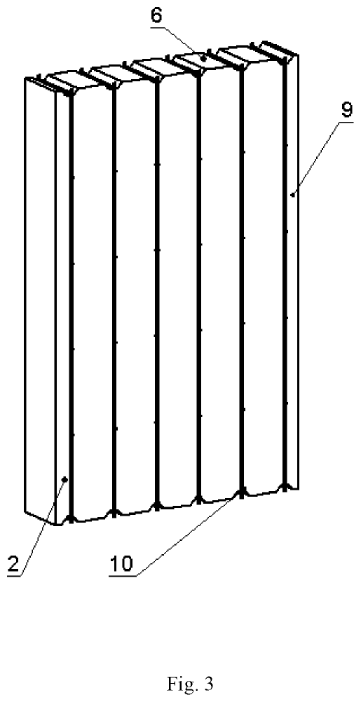

FIG. 3—general view of the panel used as floor slabs;

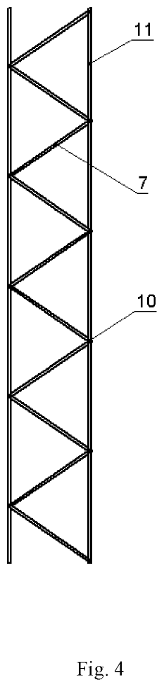

FIG. 4—general view of a reinforcing supporting element of a panel used as floor slabs;

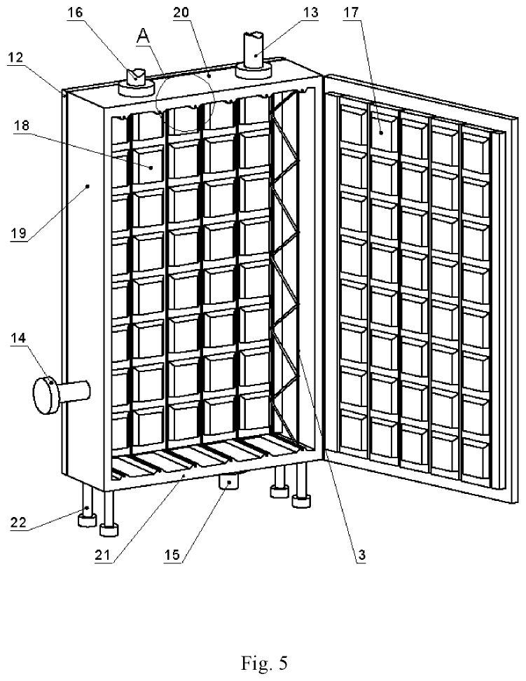

FIG. 5—general view of a block-form for making panels for load-bearing walls;

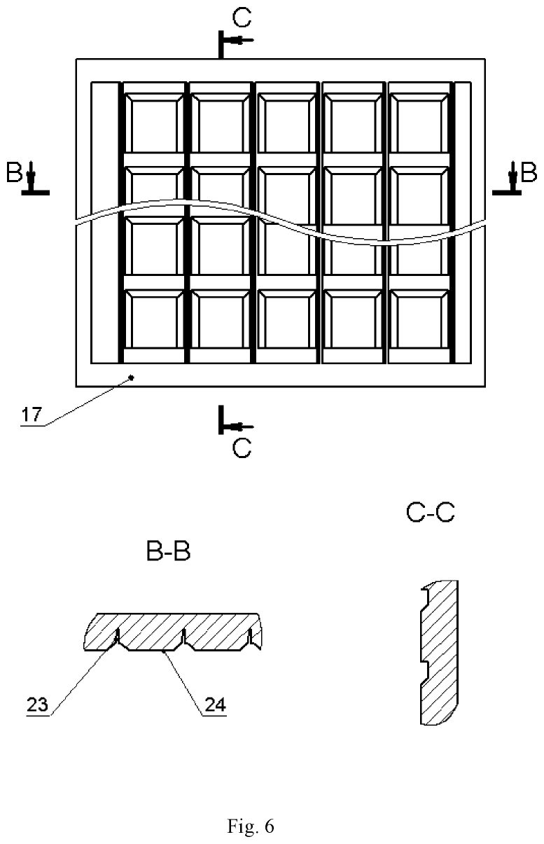

FIG. 6—front wall of the block-form for the manufacture of panels for load-bearing walls with cuts;

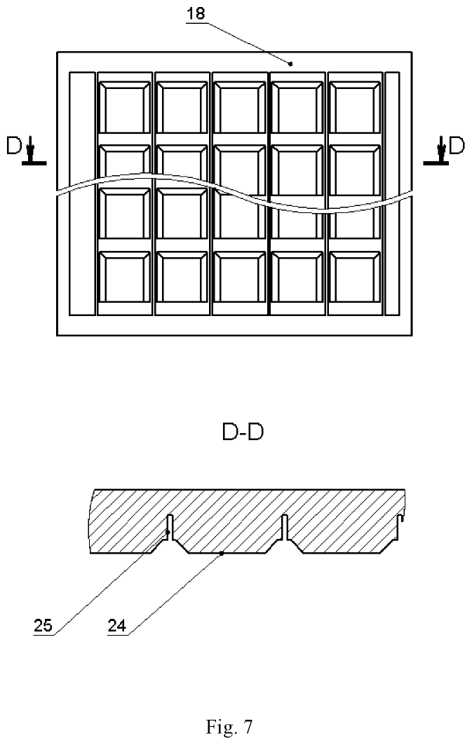

FIG. 7—back wall of the block-form for the manufacture of panels for load-bearing walls with cuts;

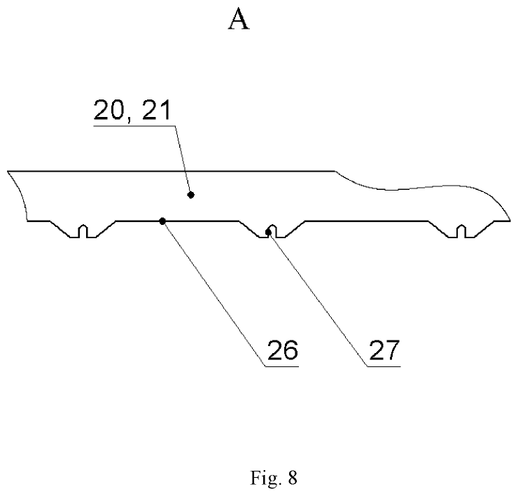

FIG. 8—view A of the upper and lower walls of the block-form for the manufacture of panels for load-bearing walls and for floor slabs;

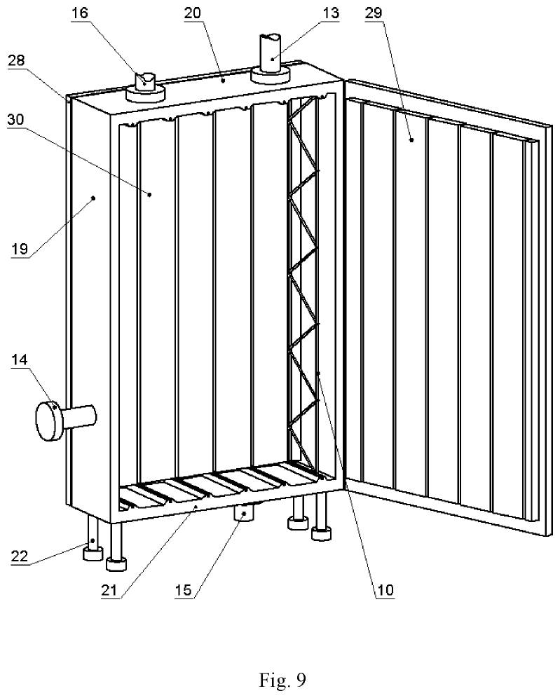

FIG. 9—general view of the block-form for the manufacture of panels used as floor slabs;

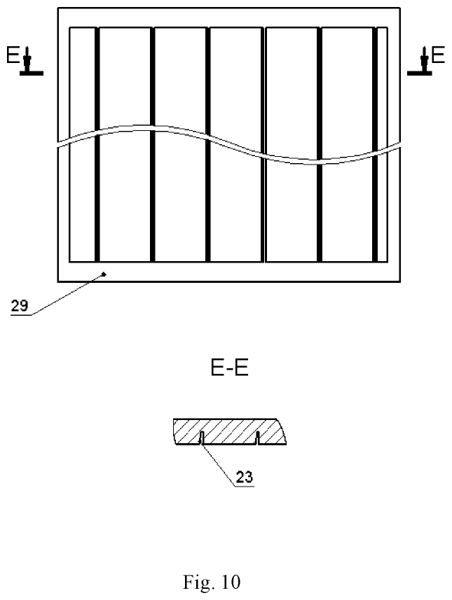

FIG. 10—front wall of the block-form for the manufacture of panels used as slabs with a cut;

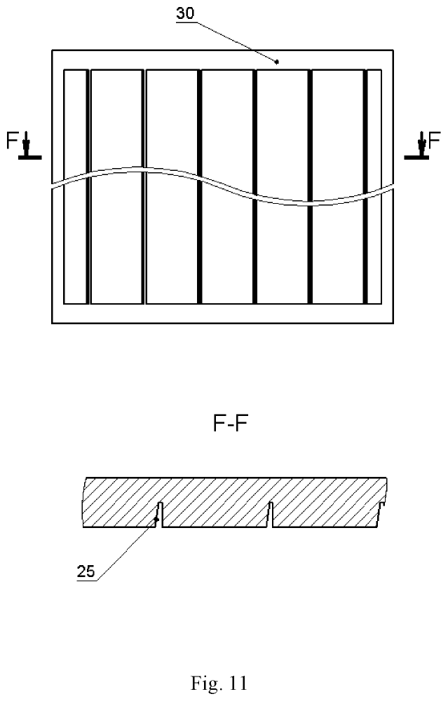

FIG. 11—back wall of the block-form for the manufacture of panels used as slabs with a cut.

Construction heat-saving three-dimensional panel 1 for load-bearing walls contains a continuous heat-insulating core 2 with a thickness of at least 300 mm (for one-two-story construction) made of a foaming material, for example polystyrene foam, inside which reinforcing supporting elements 3 are located at a predetermined interval. In the upper part of the panel 1 across the entire width there is a cavity under the seismic belt 4. Over the entire area of the front and rear surfaces of the panel 1, between the protruding surfaces of the reinforcing support elements 3, recesses 5 made in the form of a rectangular prism are located evenly and in a mutual parallel, on the top and side faces of which there are bevels at an angle of 45° degrees. The recesses 5 are formed to improve adhesion to the applied spray (or other application technology) fluid, for example cement mortar, excluding the “draining” of the solution on the smooth surface of the insulating core 2. On the upper and lower sides of the panel 1 there are protrusions 6, spaced evenly and in parallel between the protruding surfaces of reinforcing support elements 3, formed to align the lower side of the panel 1 due to the protruding parts formed in the forming process in place of guide grooves 27 on top 20 and bottom 21 walls of the block-form 12. The protrusions 6 are of trapezoidal shape.

Reinforcing supporting elements 3, made in the form of trellised trusses with a cavity under the seismic belt 4, consist of a zigzag bent rod 7, fastened by ridges on both sides in any way (for example, spot welding) with parallel longitudinal rods 8. Elements 7, 8 can be made of wire diameters from 4 mm Reinforcing support elements 3 are placed in the panel 1 so that the ridges of the adjacent zigzag bent rods 7 are staggered when viewed from the side (not shown on the drawing).

Construction heat-saving three-dimensional panel 9 used as floor slabs contains a continuous heat-insulating core 2 with a thickness of at least 300 mm (for one-two-story construction) made of a foaming material, for example expanded polystyrene, inside which reinforcing support elements 10 are located at a predetermined interval. Front and rear the surfaces of the panel 9 are smooth, with protruding surfaces of the reinforcing support elements 10. On the upper and lower sides of the panel 9, protrusions 6 are made, parallel and evenly spaced between the protruding surfaces of the reinforcing support elements 10, formed to align the lower side of the panel 9 due to the protruding parts formed in the molding process in place of the guide grooves 27 on the upper 20 and lower 21 walls of the block-forms 28. The protrusions 6 are made of a trapezoidal shape.

Reinforcing support elements 10, in the form of trellised trusses, consist of a zigzag bent rod 7, fastened by ridges on both sides in any way (for example, by spot welding) with parallel longitudinal rods 11. Elements 7, 11 can be made of a wire with a diameter of 4 mm or more. Reinforcing support elements 10 are placed in the panel 9 so that the ridges of adjacent zigzag bent rods 7 are staggered when viewed from the side (not shown in the drawing).

Panels 1, 9 may have:
cutouts, grooves, slots, holes and other design features;
elements of hidden electrical wiring;
embedded parts intended for installation operations, fastenings.

After removing the panel 1 from the block-form 12, the cutting device forms the upper part of the panel 1, leaving a layer of polystyrene foam along the inner perimeter of the cavity under the seismic belt 4.

A wire mesh with a diameter of 4-6 mm with mesh sizes of for example 50×50 mm is attached (not shown) by any means (for example, spot welding) to the protruding surfaces on the front and rear sides of the panels 1, 9 of the reinforcing support elements 3, 10.

In the manufacture of panels 1, 9 for multi-story construction, the thickness of the panel can be increased to 1000 mm or more, while the diameter of the wire used in the manufacture of reinforcing support elements 3, 10 and the diameter of the grooves 23, 25, 27 in the block-forms 12, 28 is accordingly increased.

Block-form 12 for the manufacture of panel 1 for load-bearing walls—circular, closed type, vertical design, made in the form of a sheathed and insulated rigid steel case, equipped with nozzles for connection respectively with the coolant supply system 13, vacuum 14 and condensate removal 15, loading unit 16 pre-foamed filler granules, for example expanded polystyrene. The housing consists of a movable front wall 17, rear wall 18, side walls 19, upper 20 and lower 21 walls. The block-form 12 is mounted on a support 22.

On the front wall 17, longitudinally clamped grooves 23 of generally “V” shape are made in parallel to facilitate slipping of the end face of the reinforcing support element 3 into the groove 23 when the front wall 17 is closed. On the rear wall 18, longitudinal stop grooves 25 are predominantly rectangular in shape. Forming protrusions 24 are made on the front 17 and rear 18 walls in the form of a rectangular prism, on the upper and side faces of which there are chamfers at an angle of 450 degrees. The protrusions 24 are arranged evenly and in a mutual parallel between the grooves 23, 25 along the entire width, formed to make recesses 5 in the panel 1 for the bearing walls.

On the upper 20 and lower 21 walls, parallel and evenly made transverse guide grooves 27, mainly of semicircular shape, providing the possibility of fixation for reinforcing support elements 3, performing the function of fixing and holding elements for the installed reinforcing support elements 3 before loading the pre-foamed polystyrene foam granules into the block-form 12. Parallel forming grooves 24 are made between the guide grooves 27 on the upper 20 and lower 21 walls along the entire width and to the entire depth. They have trapezoidal shapes to form protrusions 6 on the panel 1 for the bearing walls.

Block-form 28 for the manufacture of a panel 9 for floor slabs are circular. They have closed type and vertical design. It is made in the form of a sheathed and insulated rigid steel case, equipped with nozzles for connection respectively with the coolant supply system 13, vacuum 14 and condensate removal 15, loading unit 16 pre-foamed filler granules, for example expanded polystyrene. The housing consists of a movable front wall 17, rear wall 18, side walls 19, upper 20 and lower 21 walls. The block-form 28 is mounted on the support 22.

On the front wall 17, longitudinally clamped grooves 23 of a generally “V” shape are made in parallel to facilitate slipping of the end face of the reinforcing support element 10 into the groove 23 when the front wall 17 is closed. On the rear wall 18, longitudinal stop grooves 25 are predominantly rectangular in shape. On the upper 20 and lower 21 walls, transverse guide grooves 27 are made evenly and in parallel. They are mainly semicircular in shape, providing the possibility of fixation for reinforcing support elements 10, performing the function of fixing and holding elements for the installed reinforcing support elements 10 before loading the pre-foamed granules polystyrene foam block-form 28. Parallel forming grooves 24 are made between the guide grooves 27 on the upper 20 and lower 21 walls along the entire width and to the entire depth. They have trapezoidal shape to form protrusions 6 on the panel 9 for floor slabs.

The block-forms 12, 28 are used as follows.

Before loading, the reinforcing support elements 3, 10 (depending on the purpose of the panel) are installed in the guide grooves 27 made on the upper 20 and lower 21 walls in the block-form 12, 28 so that the ridges of the zigzag bent rods 7 of the adjacent supporting elements 3, 10 were located in the finished panel 1, 9 in a checkerboard pattern. Before installation, the reinforcing support elements 3, 10 are coated with an anticorrosive composition. The front movable wall 17 is closed.

The pre-foamed polystyrene granules by pneumatic transport (not shown on the drawing) are loaded into the block-form 12, 28 through the loading unit 16. Then they are heat treated, as a result of which the granules re-expand, enveloping the reinforcing support elements 3, 10, thus forming the inside installation panel 1, 9, which, after cooling and stabilization, which is performed by creating a vacuum evacuation unit through the pipe 14, is pushed out of the block-form 12, 28 by a “pneumatic pad” operating from a pneumatic cylinder (n not shown).

The formed panel 1, 9, removed from the block-form 12, 28, is transported to the welding section, where a wire mesh is attached to the protruding surfaces of the supporting elements 3, 10 by spot welding (or any other method).

For the manufacture of thermostructural panels, polystyrene foaming self-extinguishing PSV-S (or EPS-F) with flame retardants is used.

The use of the proposed Construction heat-saving three-dimensional panel, method and device for its manufacture (options) allows to obtain the following advantages.

Introduction of reinforcing supporting elements 3, 10 in the form of trellised trusses into the construction of a construction heat-insulating three-dimensional panel provides the structural rigidity and increased load capacity, allows to increase the rate of withstand vertical load, which makes it possible to use ready-made panels not only as enclosing structures, but also as supporting structures, also makes it possible to install a seismic belt without formation of a cold bridge, due to the layer of the expanded polystyrene left on both inner sides of the cavity under the crossbar 4.

Execution of a heat-insulating core 2 with a thickness of 300 mm (for one-two-story construction) and up to 1000 mm and more (for multi-story construction) meets the requirements of thermal resistance index of the external walls for a “passive house” which is equal to R≥6.7 (m2° C.)/W (https://www.smartcalc.ru/thermocalc?&gp=229&rt=0&ct=0&o s=0&ti=20&to=-10&hi=55&ho=85). To produce the required panel 1, 9, the minimum thickness of the expanded polystyrene was determined in the amount of 300 mm, the thermal resistance of which is equal to R=6.98 (m2° C.)/W, which exceeds the required indicator of the European standard for a “passive house”.

Execution in the panel 1 for the bearing walls of the cavity under the seismic belt 4, on the inner perimeter of which there is a layer of expanded polystyrene, makes it possible to install the seismic belt without formation of a cold bridge, due to the layer of the expanded polystyrene left on both inner sides of the cavity under the crossbar 4.

Execution in the panel 1 of the recesses 5, formed to improve adhesion to the spray (or other application technology) of a fluid, such as cement mortar, eliminates the “runoff” of the solution on the smooth surface of the insulating core 2.

Using the proposed invention will reduce labor costs, the time of construction of objects, will exclude the use of lifting equipment, while the construction can be performed all year round.

1. Construction heat-insulating three-dimensional panel containing a heat-insulating core with reinforcing support elements installed inside it, wire nets located parallel to its surfaces on both sides, bonded to the surfaces of reinforcing support elements protruding over the core, distinguished with a fact that the reinforcing support elements are made in the form of lattice trusses with a cavity under the seismic belt, between the protruding surfaces of reinforcing support elements over the entire area of the front and rear surfaces of the panel are aligned evenly and in mutual parallel to the recesses, and on the upper and lower sides of the panel over the entire width, the protrusions are made evenly and in parallel.

2. The panel according to cl. 1, is distinguished with a fact that the recesses are in the form of a rectangular prism, on the upper and side faces of which the chamfers are made at an angle of 450.

3. The panel according to cl. 1, is distinguished with a fact that the protrusions are trapezoidal in shape.

4. Construction heat-insulating three-dimensional panel containing a heat-insulating core with reinforcing support elements installed inside it, wire meshes parallel to its surfaces on both sides, bonded to surfaces of reinforcing support elements protruding above the core, distinguished with a fact that the reinforcing support elements are made in the form of lattice trusses, the front and rear surfaces of the panel are made smooth and on the upper and lower sides of the panel over the entire width, protrusions located between the protruding surfaces awns of reinforcing support elements are made evenly and in parallel.

5. According to cl. 4, the panel is distinguished with a fact that the protrusions are made in a trapezoidal shape.

6. A method of manufacturing a construction heat-insulating three-dimensional panel, comprising the filling of a cavity of a block-form, the forming surfaces of which are coated with non-stick lubricant, pre-foamed polystyrene granules, closing the block-form, forming the blocks by applying the water vapor by “heat shock” method to the block-form, cooling, opening the block-form and removing the finished blocks from the block-form by pushing to achieve a form temperature of 40-45° C., distinguished with a fact that the form is filled after installation in the guide grooves pouring the support elements.

7. The closed-type block-form, made in the form of a vertically oriented housing mounted on a support, equipped with nozzles for connecting respectively with the coolant supply, vacuum and condensate removal systems, a pre-foamed filler granules loading unit, consisting of a movable front wall, back wall, side walls, upper and lower walls, distinguished with a fact that Longitudinal persistent grooves are made on the rear wall, between which the forming protrusions are made evenly and in and in mutual parallel. There are transverse guide grooves on the upper and lower wall, between which the forming grooves are made.

8. According to cl. 7, the block-form is distinguished with a fact that the longitudinal pressing grooves are made of generally “V” shape.

9. According to cl. 7, the block-form is distinguished with a fact that the longitudinal thrust grooves are generally rectangular in shape.

10. According to cl. 7, the block-form is distinguished with a fact that the transverse guide grooves are generally semicircular in shape.

11. According to cl. 7, the block-form is distinguished with a fact that the forming protrusions are in the form of a rectangular prism, on the upper and lateral sides of which are bevels at an angle of 450.

12. According to cl. 7, the block-form is distinguished with a fact that the forming grooves are made of trapezoidal shape.

13. The closed-type block-form, made in the form of a vertically oriented housing mounted on a support, equipped with nozzles for connecting, respectively, with the coolant supply, vacuum and condensate removal systems, a loading unit for the pre-foamed filler granules, consisting of a movable front wall, back wall, side walls, upper and lower walls, distinguished with a fact that the longitudinal clamping grooves are made on the inner surfaces of the front wall. The longitudinal grooves are made on the rear wall aligning grooves on the top and bottom wall of the transverse guide grooves, between which forming grooves are made.

14. According to cl. 13, the block-form is distinguished with a fact that the longitudinal clamping grooves are made of generally “V” shape.

15. According to cl. 13, the block-form is distinguished with a fact that the longitudinal thrust grooves are generally rectangular in shape.

16. According to cl. 13, the block-form is distinguished with a fact that the transverse guide grooves are generally semicircular in shape.

17. According to cl. 13, the block-form is distinguished with a fact that the forming grooves are made of trapezoidal shape.
